(19) United States
(12) Patent Application Publication
(10) Pub. No.: US 2019/0095848 A1
(43) Pub. Date: Mar. 28, 2019

(54) ACTION-INFORMATION PROCESSING APPARATUS

(71) Applicant: FUJI XEROX CO., LTD., Tokyo (JP)

(72) Inventor: Yutaka KOMATSU, Kanagawa (JP)

(73) Assignee: FUJI XEROX CO., LTD., Tokyo (JP)

(21) Appl. No.: 16/130,267

(22) Filed: Sep. 13, 2018

(30) Foreign Application Priority Data
Sep. 27, 2017 (JP) 2017-185631

(51) Int. Cl. G06Q 10/06; G06T 7/20

(52) U.S. Cl. CPC G06Q 10/063114; G06T 2207/30196; G06T 7/20

(57) ABSTRACT

An action-information processing apparatus includes a collection unit that collects multiple pieces of information regarding respective variables in a work environment, a first holding unit that holds the pieces of information collected by the collection unit, an action identification unit that identifies an action performed by a worker in the work environment, a detector that detects, from the pieces of information held by the first holding unit, a piece of information indicating an event having one of features predetermined in accordance with types of the pieces of information, a requesting unit that makes a request for input of a piece of information regarding a relationship between the action identified by the action identification unit and the event in the piece of information detected by the detector, and a second holding unit that holds the piece of information input in response to the request.

### CROSS-REFERENCE TO RELATED APPLICATIONS

This application is based on and claims priority under 35 USC 119 from Japanese Patent Application No. 2017-185631 filed Sep. 27, 2017.

### BACKGROUND

### (i) Technical Field

The present invention relates to an action-information processing apparatus.

### (ii) Related Art

In various types of work, a skilled worker occasionally works in different steps from those by an unskilled worker or performs an action different from actions typically performed by the unskilled worker. Such an action that is performed by the skilled worker and that effects work differently from the actions by the unskilled worker is requested to be inherited as a skill of the skilled worker.

An action of a worker that is different from those typically performed by other workers in a work place or the like is likely to contribute to work effect improvement but is performed for unexplained reasons without being verbalized even by the worker themselves (so-called tacit knowledge) in some cases. Since such an action is not verbalized and thus not explained, it is difficult to reuse (inherit) the action as a technique, unlike procedures taken over by using an instruction manual or the like.

### SUMMARY

According to an aspect of the invention, there is provided an action-information processing apparatus includes a collection unit, a first holding unit, an action identification unit, a detector, a requesting unit, and a second holding unit. The collection unit collects multiple pieces of information each regarding a corresponding one of multiple variables in a work environment. The first holding unit holds the pieces of information collected by the collection unit. The action identification unit identifies an action performed by a worker in the work environment. The detector detects, from the pieces of information held by the first holding unit, a piece of information indicating an event having one of features that are predetermined in accordance with types of the pieces of information. The requesting unit makes a request for input of a piece of information regarding a relationship between the action identified by the action identification unit and the event in the piece of information detected by the detector. The second holding unit holds the piece of information input in response to the request made by the requesting unit.

### BRIEF DESCRIPTION OF THE DRAWINGS

An exemplary embodiment of the present invention will be described in detail based on the following figures, wherein:

FIG. 1 is a diagram illustrating the configuration of an action-information processing apparatus to which the exemplary embodiment is applied;

FIG. 2 is a table illustrating example object attribute information;

FIG. 3 is a table illustrating example inspection-value information;

FIG. 4 is a table illustrating example work-related information;

FIG. 5 is a diagram illustrating an example configuration of the hardware of a computer used as the action-information processing apparatus;

FIG. 6 is a flowchart illustrating operations of the action-information processing apparatus;

FIG. 7 is a diagram illustrating an example question screen; and

FIG. 8 is a diagram illustrating another example question screen.

### DETAILED DESCRIPTION

### Configuration of Action-Information Processing Apparatus

Hereinafter, an exemplary embodiment of the present invention will be described in detail with reference to the attached drawings.

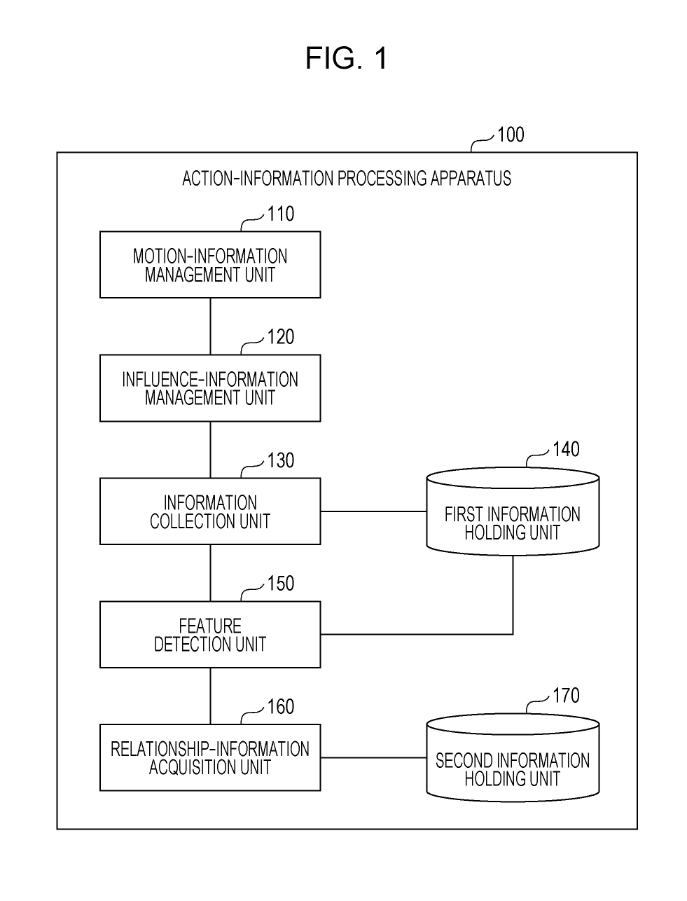

FIG. 1 is a diagram illustrating the configuration of an action-information processing apparatus to which this exemplary embodiment is applied. An action-information processing apparatus 100 of this exemplary embodiment includes a motion-information management unit 110, an influence-information management unit 120, an information collection unit 130, a first information holding unit 140, a feature detection unit 150, a relationship-information acquisition unit 160, and a second information holding unit 170. The action-information processing apparatus 100 is connected to various external devices for acquiring various pieces of information regarding products, work environments, motions of workers, and the like.

The motion-information management unit 110 manages information regarding a motion of a worker (motion information). The motion information is information identifying a motion of the worker. Accordingly, the motion-information management unit 110 is an example of a motion identification unit. The motion information includes, as information identifying a motion, information regarding, for example, the worker who has performed the motion, an object on which the motion has been performed, a date and time and a place when and where the motion has been performed, and the details of the motion. The motion information does not have to include all of these pieces of information and may also include a piece of information other than these pieces of information. Note that motions of the worker include not only motions performed during the work but also motions performed for operations other than the work. For example, the motions include a motion of adjusting equipment used in the work, a motion of changing the arrangement of a tool used in the work, and a motion of changing the standing position of the worker themselves or the orientation of a product that is a work object during the work. In addition, objects include not only a work object product but also equipment, a tool, and the like that are used in the work.

The motion information managed by the motion-information management unit 110 is identified with, for example, identification information regarding an object. The motion information is acquired in such a manner that, for example, the worker themselves inputs the motion information by operating an input device serving as the user interface of the action-information processing apparatus 100. The motion information may also be acquired in such a manner that a motion is identified by analyzing changes of video or sensor values acquired by a camera or a sensor installed in the work place. In this case, an analysis server (external server) provided for analysis processing may analyze the video or the sensor values, and the motion-information management unit 110 may acquire and manage the analysis result.

The influence-information management unit 120 manages information regarding an influence of a motion performed by the worker (influence information). The influence information is information identifying an influence of a motion of the worker. Accordingly, the influence-information management unit 120 is an example of an influence identification unit. The influence information includes information indicating, for example, an event having occurred on an object and a change of the state of the object. The influence information is managed in association with motion information managed by the motion-information management unit 110. The influence information managed by the influence-information management unit 120 is identified with, for example, the identification information regarding the object. The influence information is acquired in such a manner that, for example, the worker themselves inputs the influence information by operating the input device of the user interface of the action-information processing apparatus 100. The influence information may also be acquired in such a manner that an influence on the object is identified by analyzing changes of video or sensor values acquired by the camera or the sensor installed in the work place. In this case, the analysis server (external server) provided for analysis processing may analyze the video or the sensor values, and the influence-information management unit 120 may acquire and manage the analysis result.

The information collection unit 130 acquires information regarding the object and variables related to the work. The information collection unit 130 acquires, as information regarding each variable related to the object, object attribute information and inspection-value information. The information collection unit 130 also acquires, as information regarding each variable related to the work, work-related information and worker motion information. The information collection unit 130 is an example of a collection unit. These pieces of information are acquired from a server (external server) in, for example, a management system that manages products, a management system that manages equipment used in the work, or a management system that manages workers. Note that the information collection unit 130 may select and collect at least one piece of information related to an action identified among pieces of information related to the object and the work after the relationship-information acquisition unit 160 identifies the action of the worker from which relationship information is to be acquired. Processing in which the relationship-information acquisition unit 160 identifies the action of the worker from which the relationship information is to be acquired will be described later.

The object attribute information is attribute information provided for each object. Specifically, the object attribute information includes information such as a date of manufacture of the object and an inspection date and time. The object attribute information also includes information such as a size, a weight, a shape, a color, an operating rate of a movable object, and a component, depending on the type of object.

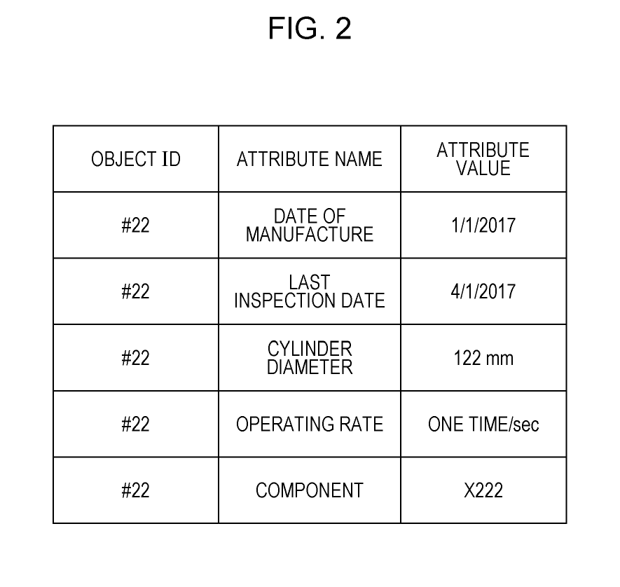

FIG. 2 is a table illustrating example object attribute information. FIG. 2 illustrates attribute information regarding a cylinder of equipment used in the work, the cylinder being an example of the object. In the example illustrated in FIG. 2, “attribute name” represents the type of attribute. The cylinder that is an object is identified with an object ID. In the example illustrated in FIG. 2, attribute values of five types of attribute that are “date of manufacture”, “last inspection date”, “cylinder diameter”, “operating rate”, and “component” are recorded for a cylinder with the object ID “*22”. Referring to an attribute value associated with “component” in the attribute name column in the example illustrated in FIG. 2, a part identified with the ID “X222” is attached to the cylinder with the object ID “*22”.

The inspection-value information is information regarding an inspection value associated with the attribute of each object. The inspection value is an actual measurement obtained by inspecting the object. Acquisition of the inspection value in the inspection-value information is repeated over time. Taking the inspection-value information into consideration thus enables changes of the attribute of the object to be followed over time.

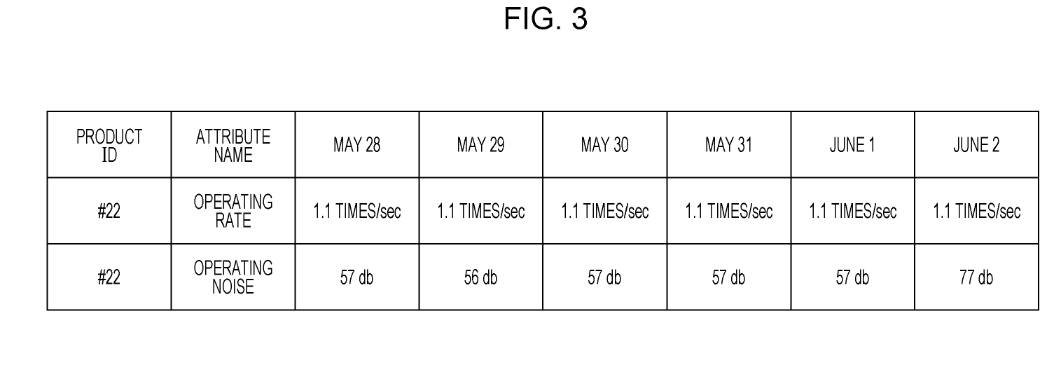

FIG. 3 is a table illustrating example inspection-value information. In FIG. 3, inspection values of two types of attribute represented by the attribute name “operating rate” and the attribute name “operating noise” are recorded for the cylinder with the object ID “*22”. An inspection value is acquired once a day, and FIG. 3 illustrates inspection values acquired from May 28 to June 2. Referring to FIG. 3, the inspection values of the operating noise are approximately 57 decibels (db) and are stable from May 28 to June 1. However, the inspection value is 77 db on only June 2 and largely deviates from the other inspection values. That is, it is understood that loud operating noise is produced abruptly on June 2.

The work-related information is attribute information regarding work. Specifically, the work-related information includes, for example, environment information such as room temperature and information regarding the worker who has performed the work. Each piece of information in the work-related information is identified with, for example, a place and a date and time where and when the corresponding work has been performed.

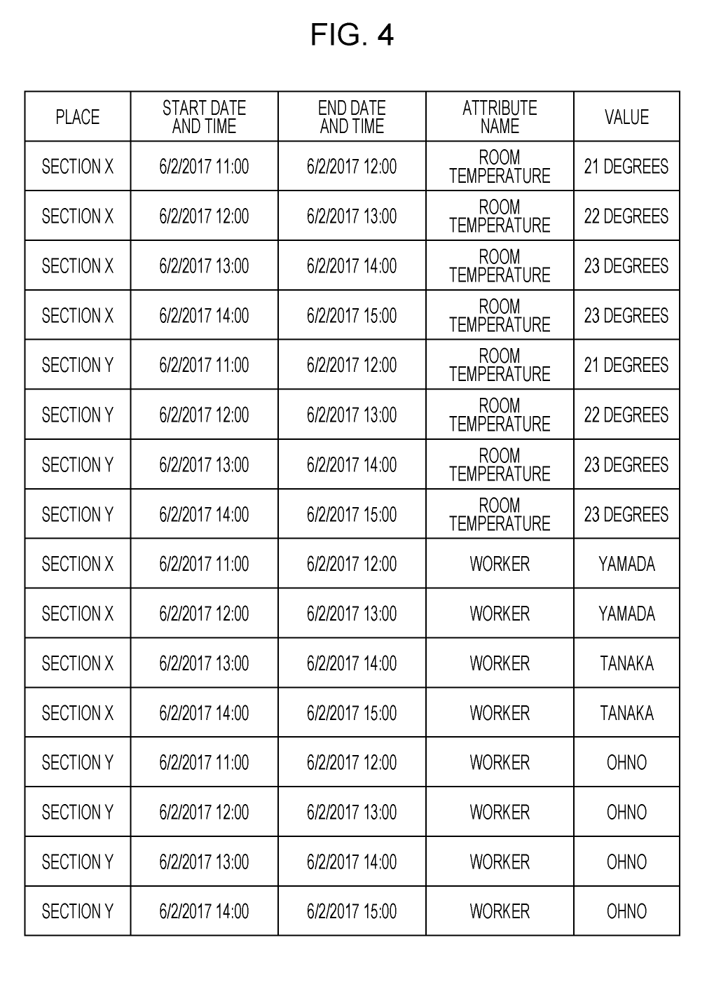

FIG. 4 is a table illustrating example work-related information. In the example illustrated in FIG. 4, “place” is used to identify a place where work has been performed, “start date and time” and “end date and time” are used to identify time when the work has been performed, and “attribute name” and “value” represent the type of attribute and an attribute value, respectively, as attribute information. The example in FIG. 4 illustrates attribute information regarding the attribute name “room temperature” and the attribute name “worker” in two places “Section X” and “Section Y” in time periods from 11:00 to 12:00 on Jun. 2, 2017, from 12:00 to 13:00, from 13:00 to 14:00, and from 14:00 to 15:00.

The worker motion information is information identifying a motion of the worker. Motions of the worker include motions performed during the work and motions performed for operations other than the work that are performed during the work. For example, the motions include a motion of changing the standing position or the posture of the worker and other motions. Information regarding such motions is acquired by analyzing video taken by a camera, sensor values of motions detected by various sensors, or the like, the camera and sensors being installed in the work place. When information regarding a motion is acquired on the basis of the video or the sensor values, a certainty factor of the motion may be added to the acquired information regarding the motion. It is conceivable that the details of the certainty factor of the motion are evaluated and discriminated from each other on a several point scale based on, for example, a case where the motion is judged to certainly have been performed and a case where the motion possibly have been performed. Information regarding the certainty factor to be added to the worker motion information may be, for example, information indicating the details of evaluation such as “the motion has been performed”, “the motion probably has been performed”, and “the motion possibly has been performed” or a numerical value representing the point scale of the evaluation (such as a percentage by which 100% represents a case where the motion has certainly been performed or a numerical value on a ten point scale by which the maximum value represents the case where the motion certainly has been performed). Each piece of worker motion information is identified on the basis of information regarding time and a place when and where the work has been performed, the worker, and the like. An example of the worker motion information is not particularly illustrated.

The first information holding unit 140 is a holding unit that holds information acquired by the information collection unit 130. That is, the first information holding unit 140 is an example of a first holding unit. The information held in the first information holding unit 140 is referred to in processing performed by the feature detection unit 150.

The feature detection unit 150 is a processing unit that detects, among pieces of information held in the first information holding unit 140, a piece of information indicating a specific event. The detected event has one of features that are predetermined in accordance with the types of pieces of information held in the first information holding unit 140. Various events may be set specifically for the configuration for the work, such as the variable, the type of attribute value, a work object product, the environment of a work place, the type of work, a management system configuration for the product or the work, which are provided as information. For example, an abrupt change of a variable value or an attribute value in changes over time, an excess of the variable value or the attribute value over a predetermined threshold, or the number of occurrences or frequency of such a change may be set as a criterion for detection as an event. The feature detection unit 150 is an example of a detector.

The relationship-information acquisition unit 160 acquires information regarding a relationship between a motion managed by the motion-information management unit 110 and an event indicated by the information detected by the feature detection unit 150. The relationship-information acquisition unit 160 acquires the information regarding the relationship between the motion and the event (relationship information) by receiving input from the worker who has performed the motion. Specifically, the relationship-information acquisition unit 160 presents a question about a relationship between the motion and the event and requests an answer from the worker who has performed the motion. The relationship-information acquisition unit 160 receives the answer to the presented question, the answer being made by the worker who has performed the motion. Accordingly, the relationship-information acquisition unit 160 is an example of a question presenting unit and is also an example of an inquiring unit. The relationship-information acquisition unit 160 is also an example of an answer receiving unit. To present the question and receive the answer, for example, a question screen including a question display for displaying a question and an answer input part for inputting the answer is displayed on a display, and the answer input in the answer input part is received. The relationship-information acquisition unit 160 is also an example of a requesting unit. Note that the relationship-information acquisition unit 160 presents the question, for example, in such a manner as to prepare questions in advance and select and present a question appropriate for the motion and the detected event for which the relationship is to be asked. If the motion and the event include a variable (such as a case where a date and time is designated or a case where the number of occurrences of the event is set as the detection criterion), the variable is acquired from information regarding event occurrence and is inserted in the question.

In addition, the relationship-information acquisition unit 160 identifies a motion having any influence on the basis of the motion information managed by the motion-information management unit 110 and the influence information managed by the influence-information management unit 120. If a motion performed by the worker has an influence, the motion performed by the worker for the influence is referred to as an action of the worker. Specifically, the relationship-information acquisition unit 160 identifies an action having an influence among motions managed by the motion-information management unit 110. The relationship-information acquisition unit 160 performs the above-described processing for acquiring relationship information, regarding the action that is the identified motion. Accordingly, the motion-information management unit 110, the influence-information management unit 120, and the relationship-information acquisition unit 160 are examples of an action identification unit.

A motion having an influence is identified, for example, in the following manner. A rule for judging occurrence of a certain influence from a certain motion is set in advance on the basis of the motion information managed by the motion-information management unit 110 and the influence information managed by the influence-information management unit 120. For example, a rule for judging occurrence of an influence as below may be set. Specifically, if a date and time when a motion identified by the motion information managed by the motion-information management unit 110 has been performed and a date and time when an influence identified by influence information managed by the influence-information management unit 120 has occurred have a specific relationship, the motion is judged to have the influence. Alternatively, a rule for judging occurrence of an influence as below may be set. Specifically, if an object as a motion target and an influenced object have a specific relationship, the motion is judged to have the influence. If the influence of a certain motion is judged to occur in accordance with any of the rules, the relationship-information acquisition unit 160 acquires relationship information, regarding the motion as an action having an influence.

In addition, a relationship-information acquisition unit 160 selects, for the motion identified as the action having an influence as described above, an event to be described in an inquiry and presents a question. To select the event to be described in the inquiry, a rule as below is set. Specifically, for example, if the date and time when the motion identified as the action has been performed and the date and time when the event has occurred have a specific relationship, an inquiry about the event is made.

The second information holding unit 170 is a holding unit that holds the information regarding the relationship between the motion and the event acquired by the relationship-information acquisition unit 160. That is, the second information holding unit 170 is an example of a second holding unit.

### Computer Hardware Configuration

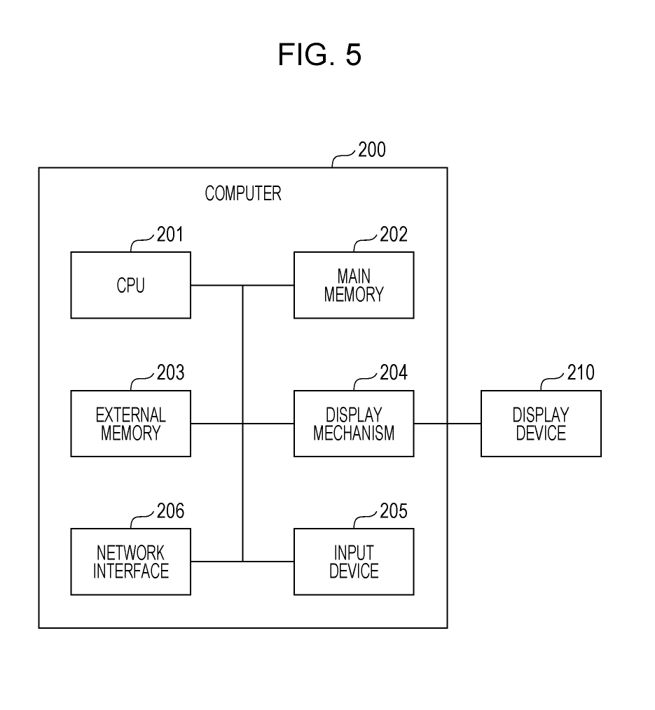

FIG. 5 is a diagram illustrating an example configuration of the hardware of a computer used as the action-information processing apparatus 100. A computer 200 illustrated in FIG. 5 includes a central processing unit (CPU) 201, a main memory 202, and an external memory 203. The CPU 201 is an arithmetic unit, and the main memory 202 and the external memory 203 are memories. The CPU 201 loads a program stored in the external memory 203 in the main memory 202 and runs the program. As the main memory 202, for example, a random access memory (RAM) is used. As the external memory 203, for example, a magnetic disk device or a solid state drive (SSD) is used. The computer 200 further includes a display mechanism 204 and an input device 205. The display mechanism 204 is provided for display output to a display device (display) 210, and the input device 205 is used by an operator of the computer 200 to perform input operations. As the input device 205, for example, a keyboard and a mouse are used. The computer 200 further includes a network interface 206 for connecting to a network. Note that the configuration of the computer 200 illustrated in FIG. 5 is merely an example, and the configuration of the computer in this exemplary embodiment is not limited to the example configuration in FIG. 5. For example, a non-volatile memory such as a flash memory or a read only memory (ROM) may be included as the memory.

In the action-information processing apparatus 100 illustrated in FIG. 1, the motion-information management unit 110 and the influence-information management unit 120 are implemented by, for example, the CPU 201 controlled by a program and the memories such as the main memory 202 and the external memory 203. The information collection unit 130 is implemented by, for example, the CPU 201 controlled by the program and the network interface 206. The first information holding unit 140 and the second information holding unit 170 are implemented by, for example, memories such as the main memory 202 and the external memory 203. The feature detection unit 150 is implemented by, for example, the CPU 201 controlled by the program. The relationship-information acquisition unit 160 is implemented by, for example, the CPU 201 controlled by the program, the display mechanism 204, the display device 210, and the input device 205. The question screen generated by the relationship-information acquisition unit 160 is displayed on the display device 210 by the display mechanism 204. The worker operates the input device 205, and an answer to a question displayed on the question screen is thereby input. In the case where the worker themselves inputs the motion information and the influence information in the motion-information management unit 110 and the influence-information management unit 120, respectively, for example, the input device 205 illustrated in FIG. 5 is used as the input device.

### Operations of Action-information Processing Apparatus

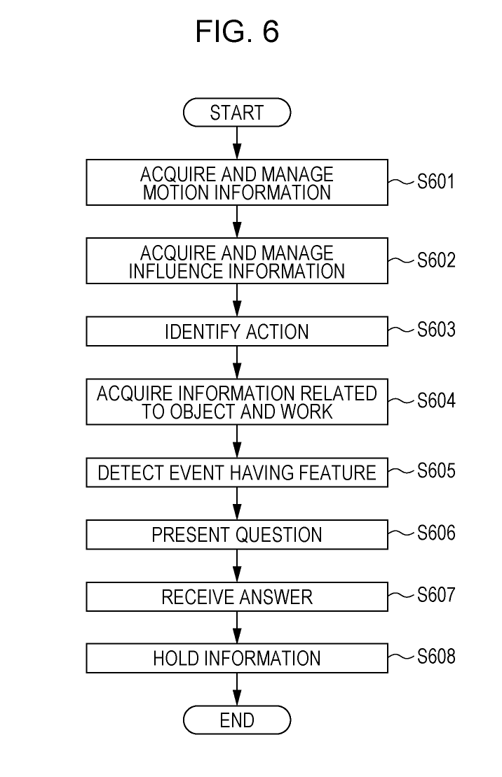

FIG. 6 is a flowchart illustrating operations of the action-information processing apparatus 100. The action-information processing apparatus 100 acquires and manages the motion information by using the motion-information management unit 110 (S601). The action-information processing apparatus 100 acquires and manages the influence information by using the influence-information management unit 120 (S602). The relationship-information acquisition unit 160 of the action-information processing apparatus 100 identifies an action by a worker on the basis of the motion information held in the motion-information management unit 110 and the influence information held in the influence-information management unit 120 (S603). The information collection unit 130 acquires information related to an object and work (S604).

The feature detection unit 150 of the action-information processing apparatus 100 detects information indicating an event having a specific feature (S605). The relationship-information acquisition unit 160 generates and presents a question about a relationship between the motion identified as the action in S603 and the event having the specific feature in the information detected in S605 (S606). Upon receiving an answer input by the worker who has performed the motion identified as the action in S603 (S607), the relationship-information acquisition unit 160 causes the second information holding unit 170 to hold, in accordance with the input answer, the motion information and the influence information regarding the inquiry target motion (action) and information indicating the relationship based on the answer (S608).

### First Application Example

An application example of this exemplary embodiment will be described. A person in charge of maintenance of equipment in a work place is herein a worker, and a process for detecting an action for facility maintenance will be described. The maintenance person (hereinafter, a worker) who is a skilled worker has performed a motion of filling 5 milliliters (ml) of oil into one of cylinders of the equipment in the work place. Identification information regarding the cylinder into which the oil has been filled is *22. The oil has been filled into the cylinder *22 on Jun. 2, 2017. The cylinder *22 is included in the equipment installed in the work place “Section X”.

The worker is aware of the motion of filling the oil into the cylinder *22. Motion information is input by the worker themselves and managed by the motion-information management unit 110. The worker recognizes a smooth operation of the cylinder *22 as an influence of the oil filling. Influence information is input by the worker themselves and managed by the influence-information management unit 120. On the basis of the motion information and the influence information, the relationship-information acquisition unit 160 determines the motion of filling the oil into the cylinder *22 as an action from which relationship information is to be acquired.

The information collection unit 130 collects object attribute information, inspection-value information, work-related information, and worker motion information and stores the pieces of information in the first information holding unit 140. Among the pieces of information held in the first information holding unit 140, the feature detection unit 150 refers to pieces of information regarding dates around June 2 when the worker has performed the action of filling the oil into the cylinder *22 and detects at least one event having a feature. Referring to FIG. 2, it is understood that regarding events related to the cylinder *22, five months have passed since the manufacturing date and two months have passed since the last inspection date. Referring to FIG. 3, it is understood that the operating noise of the cylinder *22 has become about 35% louder than that on the previous day. Referring to FIG. 4, room temperature in Section X is 21 degrees in a time period from 11:00 to 12:00, 22 degrees in a time period from 12:00 to 13:00, and 23 degrees in a time period from 13:00 to 14:00 and in a time period from 14:00 to 15:00. It is also understood that in Section X, a worker is “Yamada” in the time period from 11:00 to 13:00 and a worker is “Tanaka” in the time period from 13:00 to 15:00. Accordingly, for example, if the action of filling the oil into the cylinder *22 has been performed at 13:33, room temperature is 23 degrees, and a worker is “Tanaka”.

On the basis of the predetermined rule, the relationship-information acquisition unit 160 generates a question for inquiring, by using the question screen, of the worker about the event having the feature detected by the feature detection unit 150. Specifically, the fixed phrase “Have you filled oil because XXXXX?” has been prepared, and the part “XXXXX” is replaced with a phrase based on the identified event. For example, questions as described below are herein generated.

“Have you filled oil because five months have passed since the cylinder was manufactured?”
“Have you filled oil because two months have passed since the last cylinder inspection?”
“Have you filled oil because operating noise was 35% louder than that on the previous day?”
“Have you filled oil because room temperature was 23 degrees?”
“Have you filled oil because room temperature tended to rise?”

The order of presenting questions may be determined in accordance with an appropriate rule. For example, rules for presenting the questions as below are conceivable.
Priority is given to a question about an event having a large difference from the mean value of values in information regarding the identified event.
Priority is given to a question about an event having a value that is included in information indicating the identified event and that exceeds a predetermined management value.
Priority is given to a question about an event having a larger degree of change of a value included in information indicating the identified event.
Questions are presented in order, being started with a question about an event occurring on the date and time closest to the date and time when an action from which relationship information is to be acquired has been performed.

Further, if the feature detection unit 150 detects multiple events, the order of questions about the respective events may be determined in accordance with the noticeability levels of the features of the events. For example, assume a case where “at least 10 db rise” and “at least 2 degrees rise” are set as criteria for detecting, as events to be detected by the feature detection unit 150, an event P-1 in which “noise has become at least 10 db louder” and an event P-2 in which “the temperature has become at least 2 degrees higher” and where the information collection unit 130 acquires information I-1 indicating that noise has become 30 db louder and information I-2 indicating that the temperature has become 3 degrees higher. In this case, the event P-1 and the event P-2 are detected on the basis of the information I-1 and the information I-2, respectively. Here, the noticeability level of “30 db” in the information I-1 relative to “at least 10 db rise” serving as the criterion for detecting the event P-1 is compared with the noticeability level of “3 degrees” in the information I-21 relative to “at least 2 degrees rise” serving as the criterion for detecting the event P-2. If it is judged that the noticeability level of the information I-1 is higher than the noticeability level of the information I-2, a question about the event P-1 is presented earlier. Note that a judging method or a criterion for the noticeability level is specifically set in accordance with, for example, the type of event or the environment of a work place for which the information collection unit 130 acquires information.

In addition, if the feature detection unit 150 detects events on the basis of the worker motion information collected by the information collection unit 130, the order of presenting questions about the respective events may be determined on the basis of the certainty factors of motions of the workers, the certainty factors serving as criteria for detecting the events. For example, assume a case where worker motion information is acquired on the basis of video or sensor values and where information regarding the certainty factor of a motion is added to the worker motion information. Information regarding the certainty factor is based on evaluation on a three point scale, with the maximum value being given to a case where the motion has been performed certainly. In motions detected as events by the feature detection unit 150, a motion B-1 has a certainty factor of “3”, and a different motion B-2 has a certainty factor of “2”. In this case, a question about an event detected on the basis of judgment that the motion B-1 having a higher certainty factor has been performed is presented earlier than a question about an event detected on the basis of judgment that the motion B-2 having a lower certainty factor has been performed.

Note that rules for determining the order of presenting the questions by using the question screen may be switched over in accordance with the type of action from which relationship information is to be acquired, the details of a detected event, or the like. An answer to a question may be received in various manners using alternative answers composed of an affirmative answer (for example, “Yes”) and a negative answer (for example, “No”), neutral answers (for example, “Good”, “Neither Good nor Not good”, and “Not good” are used as answers), answers with appropriate degrees (for example, points out of 100 points are input), a free answer using a phrase (for example, text is entered in an entry field), and the like. In addition, the number of presented questions may be controlled in accordance with the content of a received answer.

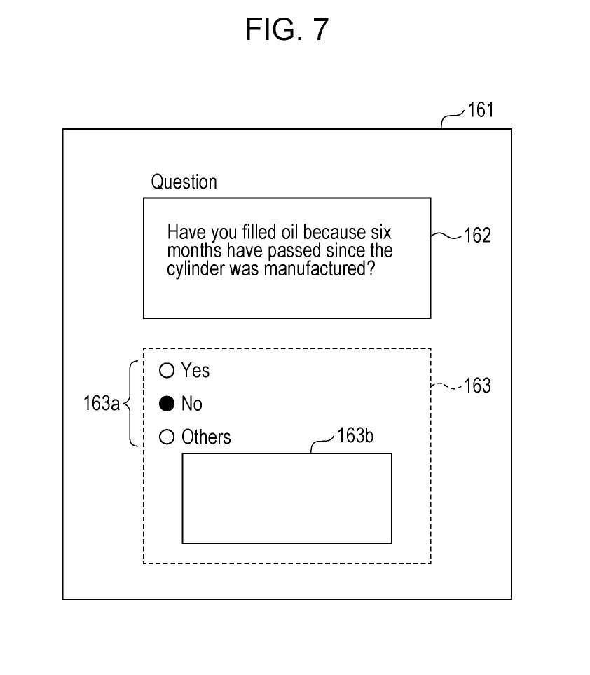

FIG. 7 is a diagram illustrating an example question screen. A question screen 161 illustrated in FIG. 7 is provided with a question display 162 and an answer input part 163. The question display 162 displays a question selected and generated as described above. In the example illustrated in FIG. 7, the question “Have you filled oil because five months have passed since the cylinder was manufactured?” is displayed. In the example illustrated in FIG. 7, the answer input part 163 is provided with a selection button 163a for selecting any one of “Yes”, “No”, and “Others” as an answer and an entry field 163b for receiving text input for a case where “Others” is selected. If the worker selects “Others” as the answer, the worker may input text in the entry field 163b as an answer to the question displayed on the question display 162. For example, if the event “five months have passed since the cylinder was manufactured” does not directly cause the action of “filling oil” performed this time but is a matter to be taken into consideration to judge whether to fill the oil, a phrase to that effect may be input in the entry field 163b as the answer to the question displayed on the question display 162 in FIG. 7.

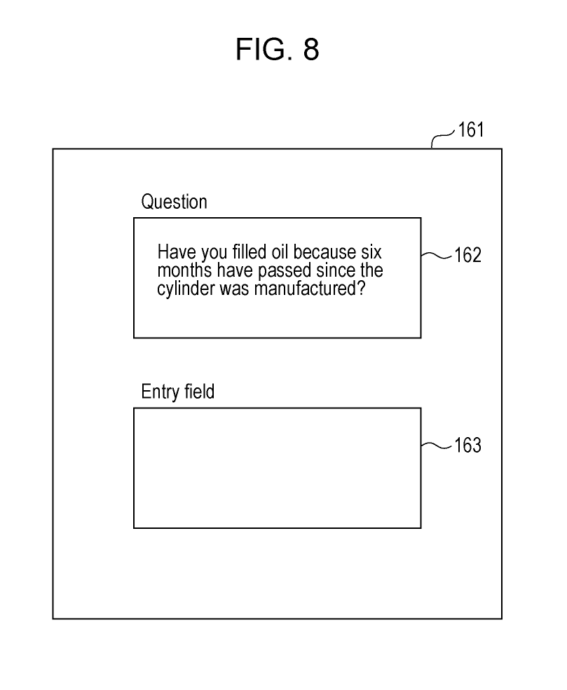

FIG. 8 is a diagram illustrating another example question screen. In the question screen 161 illustrated in FIG. 8, the question display 162 is the same as the question display 162 of the question screen 161 illustrated in FIG. 7. The answer input part 163 only has an entry field (“Enter text” in FIG. 8) for receiving text input. The use of the question screen 161 configured as described above enables the relationship-information acquisition unit 160 to acquire an answer including more specific content or detail information in the question screen 161 illustrated in FIG. 7 as in the example of input in the entry field 163b as the answer to the question (relationship information). Text such as “Yes” or “No” may also be input as an answer in the answer input part 163 illustrated in FIG. 8.

Upon receiving the answer, the relationship-information acquisition unit 160 stores, in the second information holding unit 170, motion information regarding a motion identified as an action (motion of filling oil in the cylinder in this case), influence information regarding the influence of the motion (a smooth operation of the cylinder in this case), and relationship information based on an answer from the worker (for example, an event in which operating noise has become 35% louder than that on the previous day in this case).

### Second Application Example

Another application example of this exemplary embodiment will be described. A process for detecting an action performed by a worker when they work on a product that is an object will be described. A skilled worker and an unskilled worker perform different respective motions in work beside a manufacturing line. Specifically, when working on a specific product, the skilled worker occasionally changes the standing position.

In this case, a camera takes video of the work state in the work place, and an external server (video analysis server) analyzes the video and detects a motion different from motions typically performed by the unskilled worker. Information regarding the detected motion is transmitted from the external server to the action-information processing apparatus 100 and managed by the motion-information management unit 110. The manager of the work site recognizes that work performed by the skilled worker (worker who changes the standing position during the work) has a lower fraction defective than that in work performed by the unskilled worker (a worker who does not change the standing position during the work). Information to that effect is input as influence information by the manager and managed by the influence-information management unit 120. On the basis of the motion information and the influence information, the relationship-information acquisition unit 160 determines, as an action from which relationship information is to be acquired, a motion of changing the standing position at the time when work is performed on a specific product.

The information collection unit 130 collects object attribute information, inspection-value information, work-related information, and worker motion information and stores the pieces of information in the first information holding unit 140. Among the pieces of information held in the first information holding unit 140, the feature detection unit 150 refers to pieces of information regarding dates around the date and time when the worker has performed the action of changing the standing position and detects an event having a feature. Note that if the action of changing the standing position is frequently performed, there are multiple products as objects of work accompanying the standing position changing. Accordingly, each product has object attribute information, inspection-value information, work-related information, and worker motion information associated with the date and time when the work has been performed on the product. Pieces of information categorized as the same type may be extracted and collected from the pieces of information related to the work performed on the product. The pieces of information are categorized in advance in accordance with, for example, a specific rule.

On the basis of the predetermined rule, the relationship-information acquisition unit 160 generates a question for inquiring of the worker about the event having the feature detected by the feature detection unit 150. The question is generated in the same manner as in the first application example. Specifically, for example, questions as described below are generated.

“Does the changing of the standing position have a relationship with an event in which angles of obliquely placing all of the object products on the conveyor were within a range from 45 degrees to 60 degrees?”
“Does the changing of the standing position for 20 products have a relationship with an event in which 17 products (85%) of the 20 products were removed from the line due to the tightening-torque-value failure in the previous manufacturing process?”

Note that also in the second application example, the order of presenting questions may be controlled in such a manner as to, for example, give priority to a question about an event having occurred commonly in work performed on a larger number of products than products involving with other respective events. Upon receiving an answer, the relationship-information acquisition unit 160 stores, in the second information holding unit 170, motion information regarding the motion identified as the action (motion of changing the standing position in this case), influence information regarding the influence of the motion (a decrease of the fraction defective in this case), and relationship information based on the answer from the worker (in this case, for example, the event in which the products are removed from the line due to the tightening torque value failure in the previous manufacturing process and the event in which the angles of obliquely placing the object products on the conveyor are within the range from 45 degrees to 60 degrees).

In this exemplary embodiment as described above, an action having an influence is identified among motions of a worker, an event having a feature is detected on the basis of various pieces of information collected related to an object or work, a question about a relationship between the action by the worker and the event is asked to the worker, and an answer from the worker is stored as knowledge related to the action. By presenting the question about the relationship between the action by the worker and the event, knowledge (so-called tacit knowledge) that is not recognized and not verbalized by the worker themselves comes to light, and thereby extracting the knowledge as a method implementable by an unskilled worker is assisted.

This exemplary embodiment has heretofore been described. The technical scope of this exemplary embodiment is not limited to that of the exemplary embodiment described above. Various changes and replacements of the configuration without departing from the scope of the technical idea of this exemplary embodiment are included in this exemplary embodiment. For example, the information regarding the variables collected by the information collection unit 130 is specifically set in accordance with the type or the use of a system for the work site to be supported by this exemplary embodiment, the details of the work, and the like. In addition, the method for specifically presenting questions is not limited to the methods described above. Moreover, in the above-described second application example, a motion of the skilled worker that is different from motions typically performed by the unskilled worker is detected by analyzing the video taken by the camera, but the motion of the worker may be detected after the standing position or the posture of the worker, a tool held by the worker, equipment handled by the worker, or the like is identified on the basis of sensor values acquired from a human sensor, a weight sensor, or another sensor.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An action-information processing apparatus comprising:
a collection unit that collects a plurality of pieces of information each regarding a corresponding one of a plurality of variables in a work environment;
a first holding unit that holds the pieces of information collected by the collection unit;
an action identification unit that identifies an action performed by a worker in the work environment;
a detector that detects, from the pieces of information held by the first holding unit, a piece of information indicating an event having one of features that are predetermined in accordance with types of the pieces of information;
a requesting unit that makes a request for input of a piece of information regarding a relationship between the action identified by the action identification unit and the event in the piece of information detected by the detector; and
a second holding unit that holds the piece of information input in response to the request made by the requesting unit.

2. The action-information processing apparatus according to claim 1,
wherein the requesting unit includes
a question presenting unit that generates and presents a question and
an answer receiving unit that receives input of an answer to the presented question.

3. The action-information processing apparatus according to claim 2,
wherein in accordance with a type of the action identified by the action identification unit, the question presenting unit determines a type of the question and order in which the question is presented.

4. The action-information processing apparatus according to claim 1,
wherein the action identification unit includes
a motion identification unit that identifies a motion of the worker and
an influence identification unit that identifies an event judged to be an influence of the motion.

5. The action-information processing apparatus according to claim 4,
wherein the motion identification unit receives input of information regarding the motion of the worker, analyzes the input information, and identifies a detail of the motion of the worker.

6. The action-information processing apparatus according to claim 4,
wherein the motion identification unit identifies a detail of the motion of the worker on a basis of data regarding the worker, the data being measured by a sensor installed in the work environment.

7. The action-information processing apparatus according to claim 4,
wherein the motion identification unit analyzes video of the worker and identifies a detail of the motion of the worker.

8. An action-information processing apparatus comprising:
an inquiring unit that, with respect to information regarding a variable acquired in a work environment, presents information indicating an event having a feature predetermined in accordance with a type of information and that makes an inquiry to a worker about a relationship with an action of the worker in the work environment; and
an answer receiving unit that receives input of an answer to the inquiry made by the inquiring unit.

9. An action-information processing apparatus comprising:
collection means for collecting a plurality of pieces of information each regarding a corresponding one of a plurality of variables in a work environment;
first holding means for holding the pieces of information collected by the collection means;
action identification means for identifying an action performed by a worker in the work environment;
detector means for detecting, from the pieces of information held by the first holding means, a piece of information indicating an event having one of features that are predetermined in accordance with types of the pieces of information;
requesting means for making a request for input of a piece of information regarding a relationship between the action identified by the action identification means and the event in the piece of information detected by the detector means; and
second holding means for holding the piece of information input in response to the request made by the requesting means.
